(19) United States
(12) Patent Application Publication
(10) Pub. No.: US 2020/0104828 A1
(43) Pub. Date: Apr. 2, 2020

(54) MEDIUM STORING SETTLEMENT PROGRAM, SETTLEMENT METHOD, IC CARD AND SETTLEMENT SYSTEM

(71) Applicant: Incir Inc., Tokyo (JP)

(72) Inventors: Toshiya YOKOCHI, Tokyo (JP); Kazuyoshi TOMIYASU, Tokyo (JP)

(21) Appl. No.: 16/702,666

(22) Filed: Dec. 4, 2019

Related U.S. Application Data
(63) Continuation of application No. PCT/JP2018/022675, filed on Jun. 14, 2018.

(30) Foreign Application Priority Data
Jun. 22, 2017 (JP) 2017-122034

(51) Int. Cl. G06Q 20/34; G06K 7/10

(52) U.S. Cl. CPC G06Q 20/341; G06K 7/10366

(57) ABSTRACT

Provided is a settlement program or the like which easily executes electronic money settlement with the use of a mobile terminal without an IC chip built therein. The settlement program is installed in a mobile terminal that removably holds and electrically connects an IC card including an antenna unit and a card control unit for use in electronic money settlement. The mobile terminal is capable of communicating with a server via a network. The settlement is executed at least in a case where the antenna unit is located in a communication region of a reader/writer. The settlement program executes: a reading step for reading information from the IC card; and a first determination step of determining whether to make the IC card in a state of which the mobile terminal holds and electrically connects be in a state where the settlement is enabled, based on information obtained in the reading step and information from the server.

### CROSS-REFERENCE TO RELATED APPLICATIONS

This application is a continuation application of international Patent Application No. PCT/JP2018/022675 filed on Jun. 14, 2018, which claims priority to Japanese Patent Application No. 2017-122034 filed on Jun. 22, 2017, the entire contents of which are incorporated by reference.

### TECHNICAL FIELD

The present invention relates to a settlement program and the like for electronic money settlement.

### BACKGROUND ART

In Patent Document 1 or the like, a settlement system with an IC card including an IC chip for electronic money settlement is proposed.

### CITATION LIST

### Patent Literature

### Patent Literature 1: JP 2017-4234 A

There is, however, a need to prepare a mobile terminal with an IC chip embedded.

### SUMMARY OF INVENTION

One or more embodiments of the present invention are directed a settlement program or the like, to easily execute electronic money settlement with the use of a mobile terminal without IC chip embedded.

In one or more embodiments of the present invention, a settlement program or a non-transitory computer readable medium storing such the settlement program is installed in a mobile terminal that removably holds and electrically connects an IC card including an antenna unit (antenna) and a card control unit (a card controller, which may include one or more processors) for use in electronic money settlement. The mobile terminal is capable of communicating with a server via a network. The settlement is executed at least in a case where the antenna unit is located in a communication region of a reader/writer. The settlement program executes: a reading step of reading information from the IC card; and a first determination processing step of determining whether to make the IC card in a state of which the mobile terminal holds and electrically connects be in a state where the settlement is enabled, based on information obtained in the reading step and information from the server.

Settlement of electronic money can be easily made using the mobile terminal not including an IC chip by attaching and electrically connecting the IC card, to the mobile terminal not including the IC chip.

In such a case that the IC card is electrically connected or the like, the determination on whether to make the settlement enabled state (the first determination processing step) is executed on the basis of information on said IC card and information from the server 30. Thus, to become the settlement enabled state only in the event of meeting a specific requirement can be made.

In addition, preferably, for each user, a database that indicates a relation among a user ID of the user of the IC card, a card ID of the IC card, and a terminal ID of the mobile terminal, is the information from the server. In a case where a combination of the card ID of the IC card and the terminal ID of the mobile terminal, and a combination of the card ID of another IC card other than the IC card and the terminal ID of another mobile terminal other than the mobile terminal are set in the database to correspond to the user ID, a balance display step to make the mobile terminal to display balance information on the electronic money in the IC card and balance information on the electronic money in said another IC card is executed.

On the mobile terminal electrically connected to the IC card, output of the balance information of another IC card that has a user ID in common with the user of said IC card becomes enabled.

Further preferably, in the balance display step, in a case where a first operation on the mobile terminal is executed, at least a part of the balance of the electronic money in the IC card is added to the balance of the electronic money in said another IC card, and to make the mobile terminal to display the balance of the electronic money in the IC card after the subtraction and the balance of the electronic money in said another IC card after the addition is executed.

The electronic the transfer of money transfer between the IC card and said another IC card becomes enabled.

In addition, preferably, in the balance display step, in a case where a second operation on the mobile terminal is executed, to make the server to transmit information regarding an instruction of making it impossible for said another IC card to execute the settlement is executed.

Preferably, in the first determination processing step, if was is not determined to make the settlement enabled state, a second determination processing step of determining whether to make the IC card electrically connected to the mobile terminal be in the state where the settlement is enabled, based on input of information via the mobile terminal, is executed.

The determination on whether to make the settlement enabled state (second determination processing step) is executed on the basis of whether a predetermined string is input via the mobile terminal. Thus it becomes possible to prevent someone who does not know the predetermined string (for example, someone who has stolen the IC card from the user himself/herself corresponding to the user ID) from handling any deposit/withdrawal of electronic money with the use of the IC card.

Further preferably, in a case where at least one of the user ID and a string corresponding to the user ID is input as the information input via the mobile terminal, it is determined to make the settlement enabled state in the second determination processing step.

The determination on whether to make the settlement enabled state (the second determination processing step) is executed on the basis of whether a string or the like regarding the user ID is input via the mobile terminal. Thus it becomes possible to prevent someone who does not know the user ID (for example, someone who has stolen the IC card from the user himself/herself corresponding to the user ID) from handling any deposit/withdrawal of electronic money transfer with the use of the IC card.

In addition, preferably, a card ID of the IC card and a user ID of the user of the IC card are the information read from the IC card. For each user, a database that indicates a relation among the user ID, the card ID, and a terminal ID of the mobile terminal is the information from the server. In a case where a combination of, the card ID and the user ID contained in the information read from the IC card, and the terminal ID of the mobile terminal that has read the card ID and the user ID, is contained in the database, it is determined to make the settlement enabled state in the first determination processing step.

In one or more embodiments of the present invention, a settlement method is a method for electronic money settlement in a mobile terminal that removably holds and electrically connects an IC card including an antenna unit (antenna) and a card control unit (a card controller, which may include one or more processors) for use in the electronic money settlement. The settlement is executed at least in a case where the antenna unit is located in a communication region of a reader/writer. The settlement method executes: a reading step of reading information from the IC card; and a first determination processing step of determining whether to make the IC card in a state of which the mobile terminal holds and electrically connects be in a state where the settlement is enabled, based on the information obtained in the reading step and information from a server that communicates via a network.

Preferably, for each user, a database that indicates a relation among a user ID of the user of the IC card, a card ID of the IC card, and a terminal ID of the mobile terminal is the information from the server. In a case where a combination of the card ID of the IC card and the terminal ID of the mobile terminal, and a combination of the card ID of another IC card other than the IC card, and the terminal ID of another mobile terminal other than the mobile terminal are set in the database to correspond to the user ID, a balance display step to make the mobile terminal to display balance information on the electronic money in the IC card and balance information on the electronic money in said another IC card is executed.

In one or more embodiments of the present invention, an IC card includes an antenna unit (antenna) and a card control unit (a card controller, which may include one or more processors) for use in electronic money settlement. The IC card is removably held by and electrically connected to a mobile terminal. The settlement is executed at least in a case where the antenna unit is located in a communication region of a reader/writer. A first determination processing step is executed to determine whether to make the IC card in a state of which the mobile terminal holds and electrically connects be in a state where the settlement is enabled, based on information read from the IC card by the mobile terminal and information from a server that communicates via a network, and after the first determination processing step, the settlement enabled state is made.

Preferably, for each user, a database that indicates a relation among a user ID of the user of the IC card, a card ID of the IC card, and a terminal ID of the mobile terminal is the information from the server. In a case where a combination of the card ID of the IC card and the terminal ID of the mobile terminal, and a combination of the card ID of another IC card other than the IC card, and the terminal ID of another mobile terminal other than the mobile terminal are set in the database to correspond to the user ID, a balance display step is executed to make the mobile terminal to display balance information on the electronic money in the IC card and balance information on the electronic money in said another IC card.

In one or more embodiments of the present invention, a settlement system includes a first IC card, a first mobile terminal, a second mobile terminal, and a server. The first IC card is for use in electronic money settlement. The first IC card is removably held by and electrically connected to the first mobile terminal. The second mobile terminal is another mobile terminal other than the first mobile terminal. The first IC card is electrically connected in a removable manner to the second mobile terminal. The server communicates with the first mobile terminal and the second mobile terminal via a network. The settlement is executed at least in a case where the antenna unit is located in a communication region of a reader/writer. When the first IC card is held by and electrically connected to the first mobile terminal, it is determined whether to make the first IC card electrically connected to the first mobile terminal be in a state where the settlement is enabled, based on information read from the first IC card and information from the server. When the first IC card is removed from the first mobile terminal and held by and electrically connected to the second mobile terminal, it is determined whether to make the first IC card electrically connected to the second mobile terminal be in a state where the settlement is enabled, based on information read from the first IC card and information from the server.

Preferably, the settlement system further includes a second IC card for use in the electronic money settlement. The second IC card is another IC card other than the first IC card. For each user, a database that indicates a relation among a user ID of the user of the IC card, a card ID of the IC card, and a terminal ID of the mobile terminal is contained in the information from the server. In a case where a combination of the card ID of the first IC card and the terminal ID of the first mobile terminal, and a combination of the card ID of the second IC card and the terminal ID of the second mobile terminal are set in the database to correspond to the user ID, balance information on the electronic money in the first IC card and balance information on the electronic money in the second IC card are displayed on the first mobile terminal.

As described above, one or more embodiments of the present invention provide a settlement program or the like, to easily execute electronic money settlement with the use of a mobile terminal without IC chip embedded.

### BRIEF DESCRIPTION OF DRAWINGS

FIG. 1 is a configuration diagram of a settlement system in a first state.

FIG. 2 is a diagram showing a content example of a database in the first state.

FIG. 3 is a configuration diagram of the settlement system in a second state.

FIG. 4 is a diagram showing a content example of the database in the second state.

FIG. 5 is a configuration diagram of the settlement system in a third state.

FIG. 6 is a diagram showing a content example of the database in the third state.

FIG. 7 is a flowchart showing a procedure for registering (activating) a combination of a card ID and a terminal ID in the database, which is executed in the case of attaching and then electrically connecting an IC card to a mobile terminal.

FIG. 8 is a diagram showing a content example of an available display screen displayed on a second mobile terminal.

FIG. 9 is a diagram showing a content example of an confirmation display screen displayed on the second mobile terminal.

FIG. 10 is a diagram showing a content example of a rejection display screen displayed on the second mobile terminal.

FIG. 11 is a diagram showing a content example of a self-terminal information screen displayed on a first mobile terminal.

FIG. 12 is a diagram showing a content example of the database in a fourth state.

FIG. 13 is a diagram showing a content example of an other-terminal information screen displayed on the second mobile terminal.

FIG. 14 is a diagram showing a content example of a balance information screen displayed on the first mobile terminal, before a transfer.

FIG. 15 is a diagram showing a content example of the balance information screen displayed on the first mobile terminal, after the transfer.

FIG. 16 is a diagram showing a content example of the database, after the transfer.

FIG. 17 is a diagram showing a content example of a deposit display screen displayed on the second mobile terminal, after the transfer.

FIG. 18 is a diagram showing a content example of the balance information screen displayed on the first mobile terminal, after invalidation.

FIG. 19 is a diagram showing a content example of the database, after the invalidation.

FIG. 20 is a diagram showing a content example of an invalidation completion screen displayed on a fourth mobile terminal, after the invalidation.

### DESCRIPTION OF EMBODIMENTS

The present embodiment will be described below with reference to the drawings.

It is to be noted that embodiments are not to be considered limited to the following embodiment. In addition, the content described in one embodiment is also applied to other embodiments as well in principle. In addition, respective embodiments and respective modification examples can be combined appropriately.

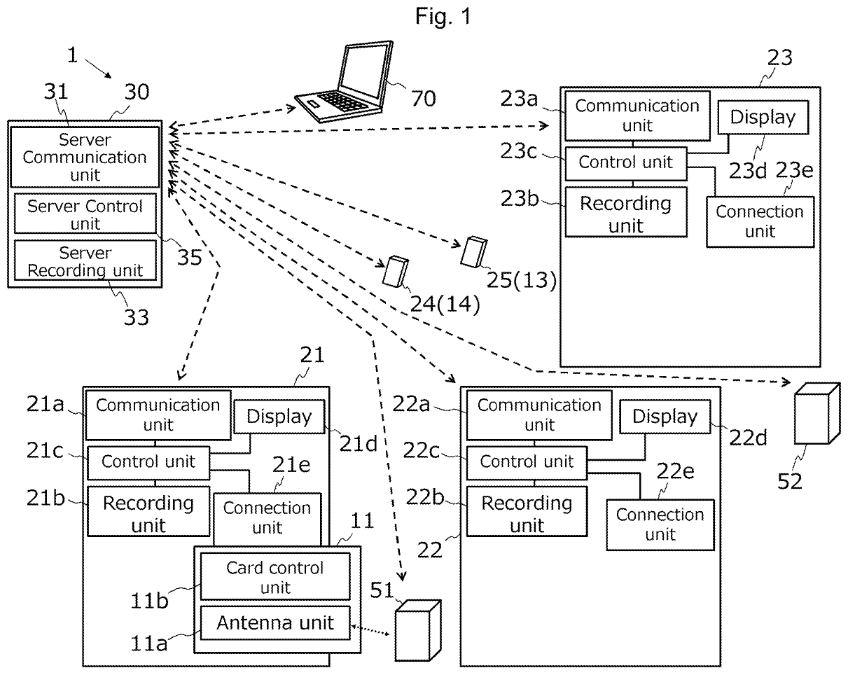

A settlement system 1 according to the present embodiment includes IC cards (a first card 11 to a fourth card 14), mobile terminals (a first mobile terminal 21 to a fifth mobile terminal 25) such as cellular phones, each of which removably holds the IC card, a server 30, and readers/writers (a first reader/writer 51, a second reader/writer 52) (see FIGS. 1, 3, and 5). The server 30 has a server communication unit (including e.g., server receiver and transmitter) 31, a server recording unit (including e.g., server data memory or server data storage) 33, a server control unit (including e.g., server controller which has one or more processors) 35.

Although the form of using four IC cards will be described in the present embodiment, the number of IC cards is not to be considered limited to four.

In addition, although the form of using five mobile terminals will be described in the present embodiment, the number of mobile terminals is not to be considered limited to five.

In addition, although the form of using two readers/writers will be described in the present embodiment, the number of readers/writers is not to be considered limited to two.

It is to be noted that the internal configuration of the first card 11 is specifically illustrated in FIG. 1, whereas the internal configurations of the third card 13 and the fourth card 14 are omitted in the figure.

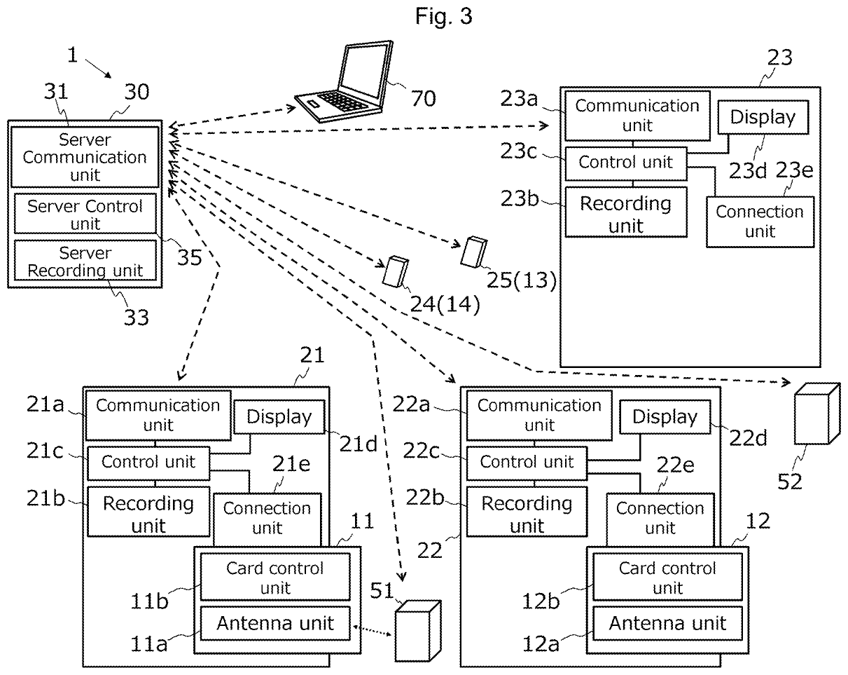

In addition, the internal configurations of the first card 11 and the second card 12 are specifically illustrated in FIG. 3, whereas the internal configurations of the third card 13 and the fourth card 14 are omitted in the figure.

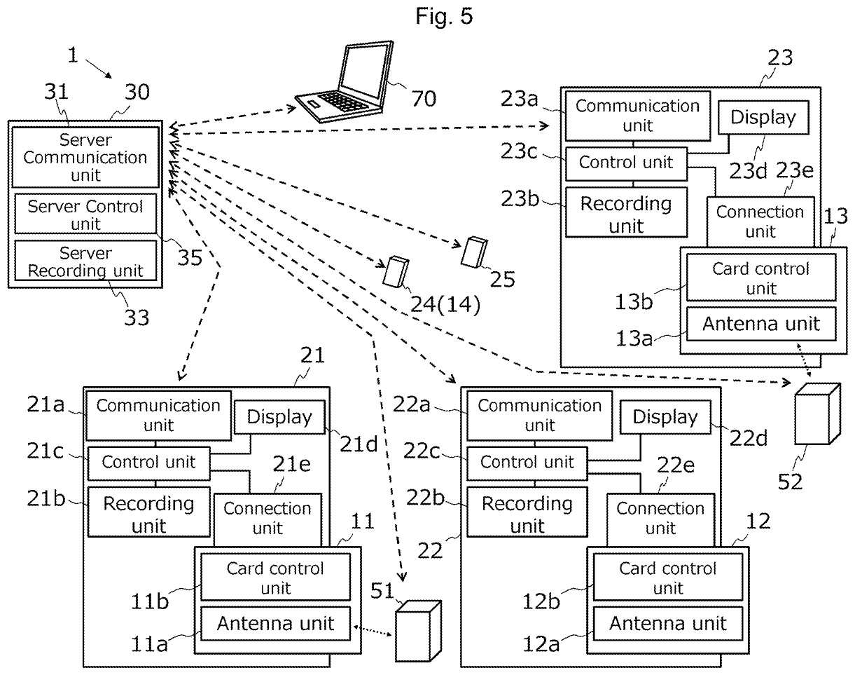

In addition, the internal configurations of the first card 11 to the third card 13 are specifically illustrated in FIG. 5, whereas the internal configuration of the fourth card 14 is omitted in the figure.

In addition, the internal configurations of the first mobile terminal 21 to the third mobile terminal 23 are specifically illustrated in FIGS. 1, 3, and 5, whereas the internal configurations of the fourth mobile terminal 24 and the fifth mobile terminal 25 are omitted in the figure.

Each of the first card 11 to the fourth card 14 has an antenna unit (including e.g., antenna) and a card control unit (including e.g., card controller (an IC chip) which may have one or more processors) and is composed of an IC card electrically connected to any of the first mobile terminal 21 to the fifth mobile terminal 25 in a removable manner, such as a SIM card (Subscriber Identity Module Card). An application for NFC (Near Field Communication) and non-contact settlement is installed in the card control unit.

It is to be noted that each of the first card 11 to the fourth card 14 is not to be considered limited to any SIM card, as long as the card is composed of an IC card electrically connected to any of the first mobile terminal 21 to the fifth mobile terminal 25 in a removable manner, with built-in applications for NFC and non-contact settlement. For example, each of the first card 11 to the fourth card 14 may be an auxiliary storage device such as an SD memory card.

Alternatively, as a form of the present embodiment, an externally connected device connected to a connector of the mobile terminal (for example, a first connection unit 21e of the first mobile terminal 21), such as a USB memory may include any of the first card 11 to the fourth card 14, and the mobile terminal may hold and electrically connect the externally connected device.

The first card 11 has a first antenna unit 11a and a first card control unit 11b.

The second card 12 has a second antenna unit 12a and a second card control unit 12b.

The third card 13 has a third antenna unit 13a and a third card control unit 13b.

The fourth card 14 also has an antenna unit and a card control unit as well (not shown).

Next, the configurations of the respective units (the first antenna unit 11a, the first card control unit 11b) in the first card 11 will be described. The antenna units and the card control units in the second card 12 to the fourth card 14 also have similar functions.

The first antenna unit 11a is used for receiving signals from the reader/writer to the first card control unit 11b and for transmitting signals from the first card control unit 11b to the reader/writer.

The first card control unit 11b, which is composed of an IC chip or the like, transmits and receives signals to and from the mobile terminal (the first mobile terminal 21) holding the first card 11 via a connection unit (connector) of the mobile terminal (a first connection unit 21e of the first mobile terminal 21), besides the transmission and reception of signals to and from the reader/writer via the first antenna unit 11a.

In a case where the first card 11 attached and electrically connected to the mobile terminal (any of the first mobile terminal 21 to the fifth mobile terminal 25), and the combination of the electrically connected mobile terminal and IC card is registered in a database D1, in a state in which the first antenna unit 11a of the first card 11 is located in a communication region of the reader/writer (any of the first reader/writer 51 and the second reader/writer 52), that is, activated, making deposit and withdrawal of electronic money via the first card 11 becomes enabled.

In a case where the first card 11 is electrically unconnected to the mobile terminal (any of the first mobile terminal 21 to the fifth mobile terminal 25), even in a state in which the first antenna unit 11a of the first card 11 is located in the communication region of the reader/writer (any of the first reader/writer 51 and the second reader/writer 52), making deposit and withdrawal of electronic money via the first card 11 is not enabled.

As a form of the present embodiment, however, even in a case where the first card 11 is electrically unconnected to the mobile terminal (any of the first mobile terminal 21 to the fifth mobile terminal 25), making deposit and withdrawal of electronic money via the first card 11 may be enabled in a state in which the first antenna unit 11a of the first card 11 is located in the communication region of the reader/writer (any of the first reader/writer 51 and the second reader/writer 52).

In a case where the first card 11 is attached and electrically connected to the mobile terminal (any of the first mobile terminal 21 to the fifth mobile terminal 25), but the combination with the mobile terminal is unregistered in the database D1, that is, not activated, even in a case where the first antenna unit 11a of the first card 11 is located in the communication region of the reader/writer (any of the first reader/writer 51 and the second reader/writer 52), making deposit and withdrawal of electronic money via the first card 11 is not enabled.

Making deposit and withdrawal of electronic money via the first card 11 is not to be considered limited to the transfer through the communication between the first antenna unit 11a and the reader/writer. As a form of the present embodiment, the transfer may be executed by settlement via the mobile terminal with the first card 11 attached and electrically connected and a network.

The first mobile terminal 21 has a first communication unit (including e.g., receiver and transmitter) 21a, a first recording unit (including e.g., data memory or data storage) 21b, a first control unit (including e.g., controller which has one or more processors) 21c, a first display 21d, and the first connection unit (including e.g., connector) 21e.

The second mobile terminal 22 has a second communication unit (including e.g., receiver and transmitter) 22a, a second recording unit (including e.g., data memory or data storage) 22b, a second control unit (including e.g., controller which has one or more processors) 22c, a second display 22d, and a second connection unit (including e.g., connector) 22e.

The third mobile terminal 23 has a third communication unit (including e.g., receiver and transmitter) 23a, a third recording unit (including e.g., data memory or data storage) 23b, a third control unit (including e.g., controller which has one or more processors) 23c, a third display 23d, and a third connection unit (including e.g., connector) 23e.

Each of the fourth mobile terminal 24 and the fifth mobile terminal 25 also has a communication unit (including e.g., receiver and transmitter), a recording unit (including e.g., data memory or data storage), a control unit (including e.g., controller which has one or more processors), a display, and a connection unit (including e.g., connector) as well (not shown).

Next, the configurations of the respective units (first communication unit 21a, first recording unit 21b, first control unit 21c, first display 21d, and first connection unit 21e) in the first mobile terminal 21 will be described. The communication units, the recording units, the control units, the displays, and the connections in the second mobile terminal 22 to the fifth mobile terminal 25 also have similar functions.

The first communication unit 21a is a wireless communication device that communicates with the server communication unit 31 of the server 30 and transmits and receives information via a network such as a telephone or a wireless LAN.

A settlement program is installed in the first recording unit 21b.

The first recording unit 21b is a non-transitory computer readable medium storing the settlement program causing the computer (first mobile terminal 21) to execute the settlement program.

The settlement program executes a first determination processing step, a second determination processing step, a deposit/withdrawal display step, a balance display step, a transfer step, an invalidation step, and the like. The settlement program makes the first display 21d to display information regarding deposit/withdrawal of electronic money of the IC card (the first card 11) connected to the first connection unit 21e, and of electronic money of another card ID corresponding to the same user ID as that of said IC card (an available display screen P1, a confirmation display screen P2, a rejection display screen P3, a self-terminal information screen P4, an other-terminal information screen P5, a balance information screen P6, a deposit display screen P7, an invalidation completion screen P8).

The specific operation of the settlement program will be described later.

The first control unit 21c controls the respective units of the first mobile terminal 21, and controls the IC card (first card 11) electrically connected to the first connection unit 21e.

The first display 21d is a display device that displays deposit/withdrawal information and balance information, and includes an input device such as a touch panel.

The input device is used for registration (activation) in the database D1 when an IC card is newly attached to the first mobile terminal 21 and connected to the first connection unit 21e, an instruction to transmit electronic money to another IC card corresponding to the same use ID, and other purposes.

The input device may have a form configured integrally with the first display 21d as in the present embodiment, or have a form configured separately from the first display 21d, such as a keyboard.

The first connection unit 21e is a connector that is electrically connected to the IC card (held by the first mobile terminal 21, among the first card 11 to the fourth card 14).

Next, the respective units (server communication unit 31, server recording unit 33, server control unit 35) of the server 30 will be described.

The server communication unit 31 communicates, via a network, with each of the communication units of the mobile terminals (the first mobile terminal 21 to the fifth mobile terminal 25) registered in the database D1, and with the readers/writers (the first reader/writer 51, the second reader/writer 52) installed in stations, shops, etc.

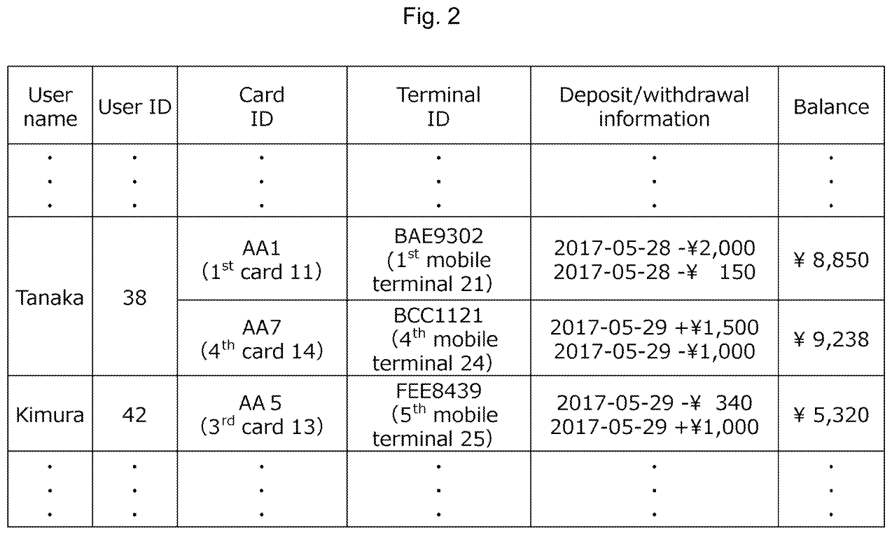

The server recording unit 33 records the database D1. The database D1 indicates a relation among a user name, identification information of the user (user ID), identification information of the IC card (card ID), identification information of the mobile terminal to which the IC card is electrically connected (terminal ID), deposit/withdrawal information of electronic money in the respective IC cards, and balance information of electronic money in the respective IC cards (see FIGS. 2, 4, and 6).

The user ID refers to a unique number assigned for each user, and an example composed of a two-digit string such as “38” is shown herein.

The user ID is assigned from an IC card provider, an electronic money service provider, or the like for providing an IC card, and the service provider uses a predetermined terminal 70 electrically connected to the IC card to cause the card control unit of the IC card to record the user ID.

As a form of the present embodiment, however, the user himself/herself may, via the input device of the mobile terminal electrically connected to the IC card, cause the card control unit of the IC card to record the user ID.

The card ID refers to a unique number assigned for each IC card, such as ICCID (Integrated Circuit Card ID), and an example composed of a three-digit string of alphabet(s) and number(s) combined, such as “AA1”, is shown herein.

Accordingly, the IC card according to the present embodiment records information regarding the user ID, together with the card ID.

The terminal ID refers to a unique number assigned for each terminal, such as IMEI (International Mobile Equipment Identifier), and an example composed of a seven-digit string of alphabets and numbers combined, such as “BAE9302”, is shown herein.

The deposit/withdrawal information provides the deposit and withdrawal histories of electronic money corresponding to the IC card.

The balance information provides the balance of electronic money corresponding to the IC card.

According to the present embodiment, FIGS. 1 and 2 show an example (a first state) where user name: TANAKA (user ID: 38) holds two IC cards (the first card 11, the fourth card 14), with the first card 11 electrically connected to the first mobile terminal 21 and the fourth card 14 electrically connected to the fourth mobile terminal 24, whereas user name: KIMURA (user ID: 42) holds one IC card (the third card 13), with the third card 13 electrically connected to the fifth mobile terminal 25.

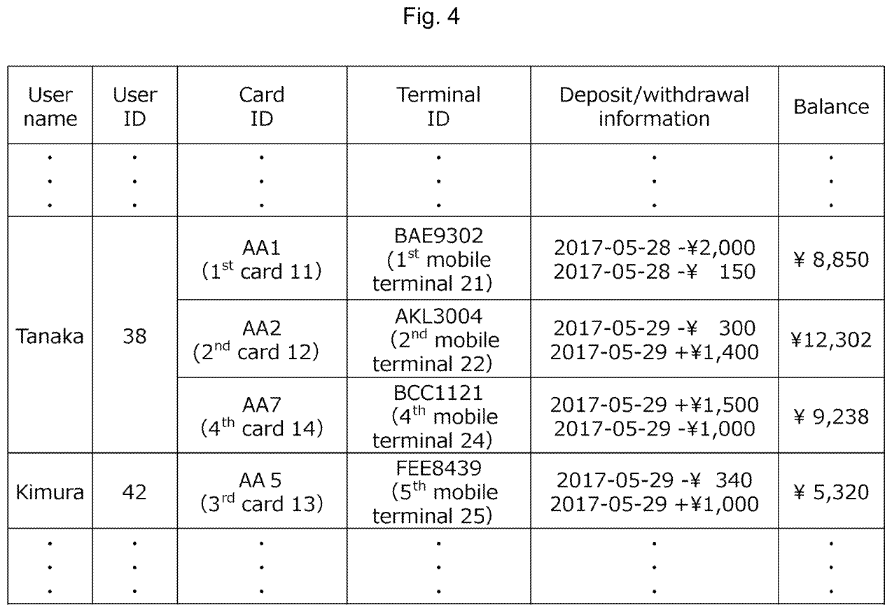

In addition, FIGS. 3 and 4 show an example (a second state) where user name: TANAKA (user ID: 38) additionally holds the third-piece's IC card (the second card 12), with the second card 12 electrically connected to the second mobile terminal 22.

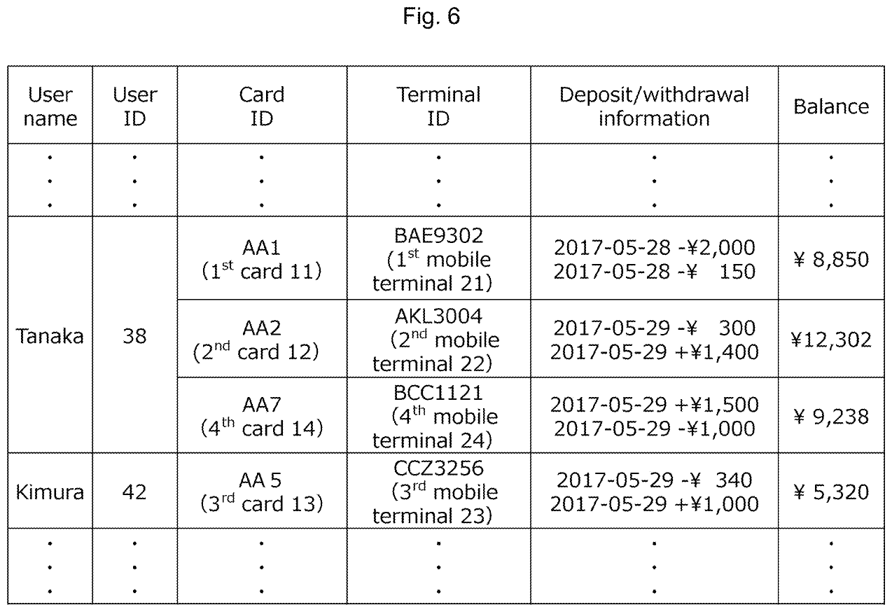

In addition, FIGS. 5 and 6 show an example (a third state) where user name: KIMURA (user ID: 42) has changed the mobile terminal electrically connected to the first-piece's IC card (the third card 13), from the fifth mobile terminal 25 to the third mobile terminal 23.

Furthermore, the server recording unit 33 has a settlement information management program installed, for transmitting and receiving information between the server 30 and the mobile terminals (the first mobile terminal 21 to the fifth mobile terminal 25), the readers/writers (the first reader/writer 51, the second reader/writer 52), and the predetermined terminal 70, and updating the information of the database D1.

The server control unit 35 executes the settlement information management program to control the server communication unit 31 and the server recording unit 33.

It is to be noted that the communication between the server 30 and the mobile terminal may be adapted to be executed in the case of deposit/withdrawal processing execution in the mobile terminal, and additionally adapted, for every first time T1 (for example, 1 minute), to acquire the deposit/withdrawal information and balance information of the IC card with each mobile terminal electrically connected thereto, as a form of the present embodiment.

In a case where the deposit/withdrawal information or the balance information is changed, the database D1 is updated.

In addition, in a case where a combination of a card ID and a terminal ID and a combination of another card ID and another terminal ID are set in the database D1 to correspond to one user ID, the deposit/withdrawal information and the balance information are transmitted to said another mobile terminal electrically connected to said another IC card.

The reader/writer (the first reader/writer 51, the second reader/writer 52) is installed in automatic ticket gates or ticket vending machines of railroads, or the like.

The reader/writer forms a magnetic field in a predetermined communication region, and communicates for deposit/withdrawal via the IC card and the antenna unit (for example, the first antenna unit 11a) located in this communication region.

Information regarding the deposit/withdrawal is transmitted from the reader/writer to the server 30.

Usually, in a case where the deposit/withdrawal of electronic money is executed via the IC card electrically connected to the mobile terminal, the deposit/withdrawal information and the balance information are then immediately transmitted from the mobile terminal to the database D1. There is thus a low possibility that the database D1 is updated, on the basis of information obtained for every first time T1.

Due to the communication situation and the like, however, there may be a situation that the deposit/withdrawal information or the balance information cannot be transmitted from the mobile terminal to the server 30 immediately after the execution of the deposit/withdrawal.

The acquisition of the deposit/withdrawal information and the balance information of the IC card held by each mobile terminal periodically for every first time T1 makes it possible to always obtain up-to-date information (the deposit/withdrawal information, the balance information) in the server 30.

Details of the settlement program will be described.

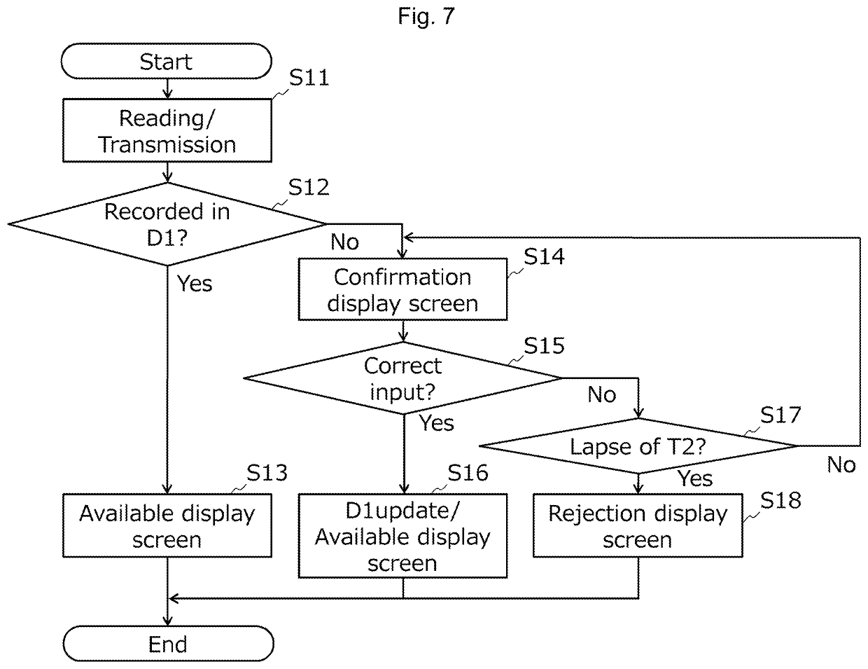

First, the execution of the first determination processing step and the second determination processing step by the settlement program, and the procedure of executing the registration (activation) of a combination of the card ID and the terminal ID in the database D1, which is executed in a case where the IC card is attached and then electrically connected to the mobile terminal, will be described with reference to the flowchart in FIG. 7.

When the IC card is attached to the mobile terminal to electrically connect the IC card and the mobile terminal, the mobile terminal reads the card ID and the user ID from the card control unit of the IC card attached to the mobile terminal, and transmits, to the server 30, information regarding the read card ID and user ID together with the terminal ID of the mobile terminal (see step S11 in FIG. 7).

The server 30 determines whether the combination of the user ID, the card ID, and the terminal ID transmitted from the mobile terminal is contained in the database D1, and transmits the determination result to the mobile terminal.

The mobile terminal determines whether confirmation of the number such as a user ID should be executed, on the basis of information regarding the determination result transmitted from the server 30 (the first determination processing step, see step S12 in FIG. 7).

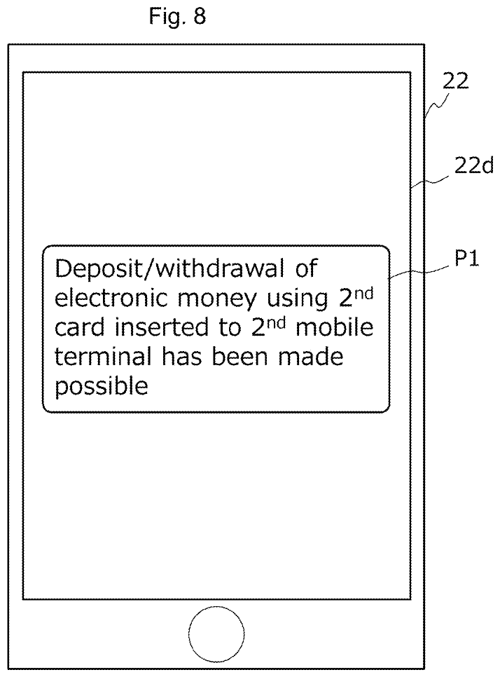

If the foregoing combination of the user ID, the card ID, and the terminal ID is contained in the database D1, it becomes in a state where the deposit and withdrawal of electronic money, that is, settlement, with the use of the IC card electrically connected to the mobile terminal can be made. The mobile terminal displays, on the display, the available display screen P1 containing a message indicating that the deposit/withdrawal has been made possible (step S13 in FIG. 7, see FIG. 8).

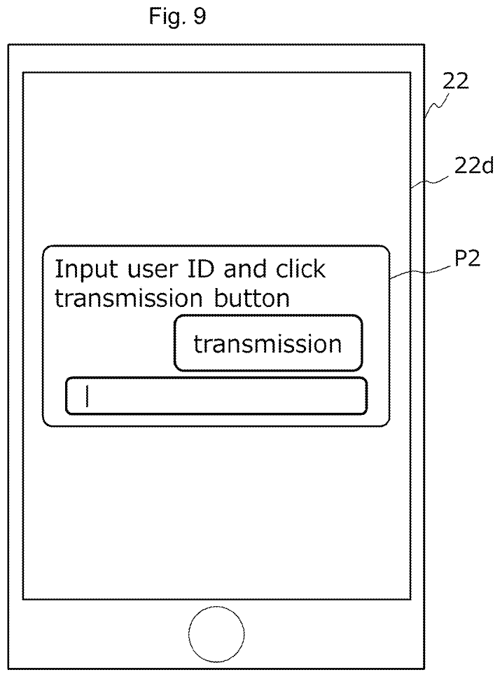

If the foregoing combination of the user ID, the card ID, and the terminal ID is not contained in the database D1, the mobile terminal displays, on the display, the confirmation display screen P2. The confirmation display screen P2 contains a message area that encourages the input of the user ID corresponding to the card ID, an area in which the user ID is input, and a transmission button for starting the transmission of input information to the server 30 (step S14 in FIG. 7, see FIG. 9).

The mobile terminal determines whether the user ID input by the user is correct, that is, whether the user ID corresponds to the IC card electrically connected to the mobile terminal (the second determination processing step, see step S15 in FIG. 7).

If the user ID input by the user is correct, the mobile terminal transmits, to the server 30, information regarding an instruction of updating the database D1. It becomes in the state where the deposit/withdrawal of electronic money with the use of the IC card electrically connected to the mobile terminal can be made. The mobile terminal displays, on the display, the available display screen P1 containing the message indicating that the deposit/withdrawal has been made possible (step S16 in FIG. 7, see FIG. 8).

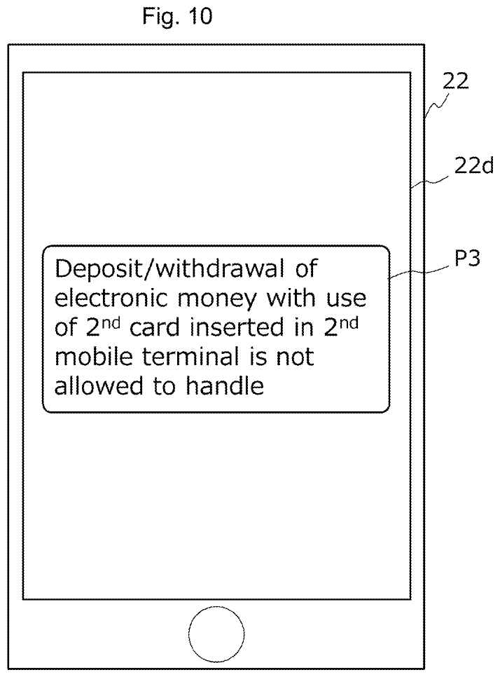

If the user ID input by the user is not correct, the steps S14 and S15 are repeated, and if the correct user ID is not input during the period from the first display of the confirmation display screen until the lapse of second time T2 (for example, T2=2 minutes), the mobile terminal displays, on the display, the rejection display screen P3 indicating that “the combination of the mobile terminal and the IC card cannot be allowed to handle the deposit/withdrawal of electronic money”, and ends the activation procedure (steps S17 and S18 in FIG. 7, see FIG. 10).

Accordingly, unless the step S13 or the step S16 is executed, the deposit/withdrawal of electronic money is not enabled to be executed with the use of the IC card electrically connected to the mobile terminal.

For example, from the first state (see FIGS. 1 and 2), when the user name: TANAKA (user ID: 38) attaches the second card 12 to the second mobile terminal 22 to electrically connect the second card 12 and the second mobile terminal 22, the second mobile terminal 22 reads the card ID: AA2 and the user ID: 38 from the second card control unit 12b of the second card 12 attached to the second mobile terminal 22, and transmits, to the server 30, information regarding the read card ID (AA2) and user ID (38) together with the terminal ID (AKL3004) of the second mobile terminal 22.

In the first state, the combination of the user ID: 38, the card ID: AA2, and the terminal ID: AKL3004 is not recorded in the database D1. Thus, the second mobile terminal 22 displays the confirmation display screen P2 on the second display 22d (see FIG. 9).

If the user of the second mobile terminal 22 has been able to input the user ID: 38 before the lapse of the second time T2, the database D1 is updated from the first state (see FIG. 2) to the second state (see FIG. 4). More specifically, the combination of the user ID: 38, the card ID: AA2, and the terminal ID: AKL3004 is added to the database D1.

In addition, it becomes in the state where the deposit/withdrawal of electronic money with the use of the second card 12 electrically connected to the second mobile terminal 22 can be made. The second mobile terminal 22 displays, on the second display 22d, the available display screen P1 containing the message indicating that the deposit/withdrawal has been made possible (see FIG. 8).

If the user of the second mobile terminal 22 has not been able to input the user ID: 38 before the lapse of the second time T2, the database D1 is not updated to remain in the first state. It does not become in the state where the deposit/withdrawal of electronic money with the use of the second card 12 electrically connected to the second mobile terminal 22 can be made. The second mobile terminal 22 displays, on the second display 22d, the rejection display screen P3 indicating that “the combination of the second mobile terminal 22 and the second card 12 cannot be allowed to handle the deposit/withdrawal of electronic money” (see FIG. 10).

As seen above, settlement of electronic money can be easily made using the mobile terminal not including an IC chip by attaching and electrically connecting the IC card, such as the first card 11, to the mobile terminal, such as the first mobile terminal 21, not including the IC chip.

In such a case that the IC card is electrically connected or the like, the determination on whether to make the settlement enabled state (the first determination processing step) is executed on the basis of information (the user ID, the card ID) on said IC card and information (the content of the database D1) from the server 30. Thus, to become the settlement enabled state only in the event of meeting a specific requirement can be made.

In addition, the determination on whether to make the settlement enabled state (the second determination processing step) is executed on the basis of whether the string or the like for the user ID corresponding to the card ID and terminal ID registered in the database D1 is input via the mobile terminal. Thus it becomes possible to prevent someone who does not know the user ID (for example, someone who has stolen the IC card from the user himself/herself corresponding to the user ID) from handling any deposit/withdrawal of electronic money with the use of the IC card.

It is to be noted that while an example where the user ID is input on the confirmation display screen P2 has been described in the present embodiment, another string (for example, a password voluntarily set by the user) corresponding to the user ID may be input as a form of the present embodiment.

In this case, a database that shows the relation between the user ID and said another string corresponding to the user ID is recorded in the server recording unit 33.

As a form of the present embodiment, the determination on whether the input string is correct after the display of the confirmation display screen P2 may be made by the mobile terminal which has received information regarding the string from the server 30, or made by the server 30 which has received information regarding the string input from the mobile terminal.

Alternatively, as a form of the present embodiment, different information from the string, such as fingerprint information and face recognition information, may be input on the confirmation display screen P2.

Next, the procedure of executing deposit/withdrawal of electronic money with the use of the IC card electrically connected to the mobile terminal with the combination of the card ID and the terminal ID registered (activated) in the database D1, that is, the procedure for the settlement program to execute the deposit/withdrawal display step, will be described.

The deposit/withdrawal is executed in a state where the antenna unit of the IC card electrically connected to the mobile terminal is located in the communication region of the reader/writer.

For example, in a case where the antenna unit is located in the communication region of the reader/writer installed in the automatic ticket gate of the railroad, the withdrawal corresponding to a predetermined train fee from the electronic money of the IC card is executed.

In a case where the antenna unit is located in the communication region of the reader/writer installed in the automatic ticket gate of the railroad to make a deposit procedure, the deposit corresponding to the deposit procedure to the electronic money of the IC card is executed.

When the deposit/withdrawal is executed, the deposit/withdrawal information and the balance information are recorded on the card control unit of the IC card, the settlement program of the mobile terminal electrically connected to the IC card executes the deposit/withdrawal display step. The deposit/withdrawal information and the balance information are displayed on the display of the mobile terminal. The deposit/withdrawal information and the balance information are transmitted to the server 30.

The server 30 updates the database D1 on the basis of the deposit/withdrawal information and balance information transmitted from the mobile terminal.

In addition, in a case where the user ID corresponding the IC card electrically connected to the mobile terminal which has transmitted the deposit/withdrawal information and the balance information corresponds to the card IDs of multiple IC cards (in a case where a combination of a card ID and a terminal ID and a combination of another card ID and another terminal ID are set in the database D1 to correspond to one user ID), the server 30 transmits the deposit/withdrawal information and the balance information to said another mobile terminal electrically connected to said another IC card.

Said another mobile terminal displays the deposit/withdrawal information and balance information received from the server 30.

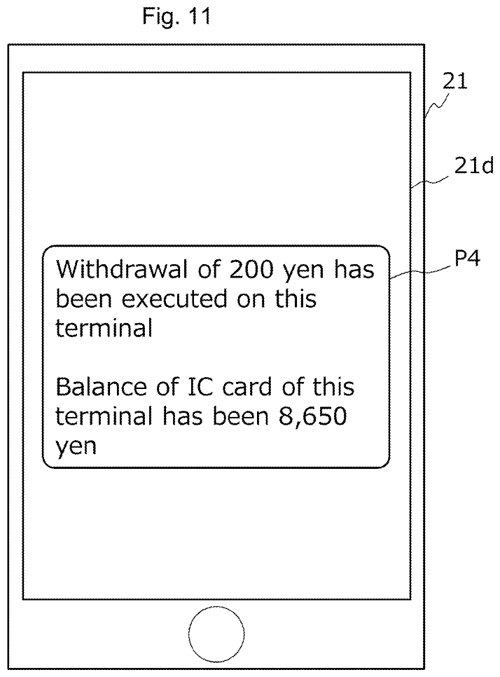

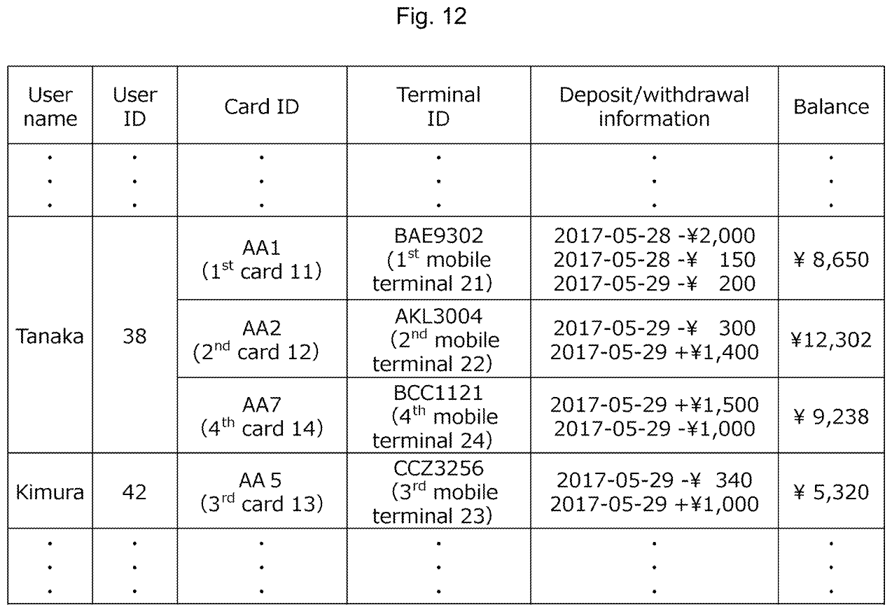

For example, from the third state, in a case where the first mobile terminal 21 is brought close to the first reader/writer 51 on May 29, 2017 so that the first antenna unit 11a of the first card 11 has been located in the communication region of the first reader/writer 51 to execute the withdrawal of 200 yen, the deposit/withdrawal information and the balance information are recorded on the first card control unit 11b, and the settlement program in the first mobile terminal 21 executes the deposit/withdrawal display step. The self-terminal information screen P4 is displayed on the first display 21d. The self-terminal information screen P4 indicates that the deposit/withdrawal has been executed on the IC card (the first card 11) of the self-terminal (the first mobile terminal 21) and indicates the balance of the IC card (the first card 11) of the self-terminal (the first mobile terminal 21). The deposit/withdrawal information and the balance information are transmitted to the server 30 via the first communication unit 21a. The database D1 is updated (a fourth state, see FIGS. 11 and 12).

The server 30 transmits the deposit/withdrawal information and the balance information of the first card 11 to the mobile terminals (the second mobile terminal 22, the fourth mobile terminal 24) electrically connected to the other IC cards (the second card 12, the fourth card 14) corresponding to the user (user ID: 38) of the first card 11.

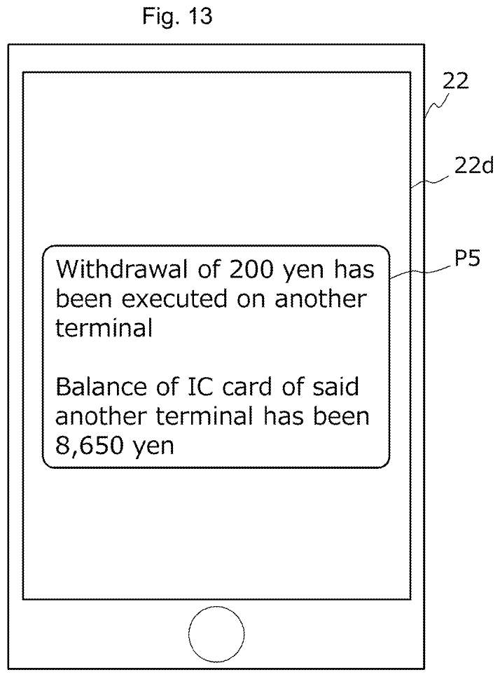

Also in the second mobile terminal 22, the deposit/withdrawal display step is executed to display the other-terminal information screen P5 on the second display 22d. The other-terminal information screen P5 indicates that the deposit/withdrawal has been executed on the IC card (the first card 11) of the other-terminal (the first mobile terminal 21) and indicates the balance of the IC card (the first card 11) of the other-terminal (the first mobile terminal 21) (see FIG. 13).

Also in the fourth mobile terminal 24, the deposit/withdrawal display step is executed as well to display the other-terminal information screen P5.

Thus, the deposit/withdrawal information and the balance information of the IC card owned by the same user is allowed to be output to the mobile terminal electrically connected to the other IC card corresponding to the same user ID.

It is to be noted that the deposit to the electronic money of the IC card is executed, not only based on the communication between the IC card and the reader/writer, but also may be executed from a credit card or another electronic money which have been registered to correspond to the user ID of the IC card, as a form of the present embodiment.

Next, the procedure in which the balance display step by the settlement program is executed, thereby the balance information of the IC card of the self-terminal and another IC card owned by the same user is displayed will be described. Furthermore, the procedure in which the transfer step by the settlement program is executed, thereby an account transfer of electronic money between IC cards is executed, will be described. Furthermore, the procedure in which the invalidation step is executed, thereby the activated specified IC card is deactivated (the IC card is invalidated), will be described.

When the user executes, on the mobile terminal electrically connected to the IC card, an operation for displaying the balance information screen P6 containing the balance information of another IC card corresponding to the same user ID, the settlement program executes the balance display step. Thereby the mobile terminal accesses the server 30 to acquire the balance information of said another IC card. The balance information screen P6 is displayed on the mobile terminal.

The acquisition of the balance information of said another IC card may be based on the database D1 which has been already recorded in a time point of when the mobile terminal accesses the server 30, as a form of the present embodiment. Or, the acquisition of the balance information of said another IC card may be based on the up-to-date balance information of said another IC card which the server 30 has been acquired by the communication with the mobile terminal electrically connected to said another IC card after this time point, as a form of the present embodiment.

The balance information screen P6 has a first display area P6a, a second display area P6b, and a third display area P6c. The first display area P6a displays the balance information of the IC card electrically connected to the self-terminal and the balance information of another IC card corresponding to the user ID of the IC card. The second display area P6b displays a transfer instruction button for executing money transfer to said another IC card. The third display area P6c displays an invalidation instruction button for invalidating said another IC card.

When the transfer instruction button is clicked (when a first operation is executed), the settlement program executes the transfer step in which a predetermined amount is withdrawn from the IC card electrically connected to the self-terminal, and the predetermined amount is deposited to another IC card corresponding to the transfer instruction button.

That is, the transfer is executed from the electronic money of the IC card electrically connected to the self-terminal, to the electronic money of another IC card corresponding to the user ID of said IC card.

When the withdrawal of the predetermined amount is executed, the deposit/withdrawal information and the balance information regarding the withdrawal (transfer) of the predetermined amount are recorded on the card control unit of the IC card. In addition, the balance information screen P6 which is displayed on the mobile terminal electrically connected to the IC card is updated. Further, the deposit/withdrawal information and the balance information are transmitted to the server 30.

The server 30 updates the database D1, on the basis of the deposit/withdrawal information and the balance information transmitted from the mobile terminal.

In addition, the server 30 transmits the deposit/withdrawal information and the balance information regarding the deposit (transfer) of the predetermined amount, another mobile terminal electrically connected to another IC card.

The deposit/withdrawal information and the balance information regarding the deposit (transfer) of the predetermined amount are recorded on the card control unit of the IC card electrically connected to another mobile terminal.

In said another mobile terminal, the settlement program executes the transfer step to display the deposit/withdrawal information and the balance information (the deposit display screen P7) regarding the deposit (transfer) of the predetermined amount, received from the server 30.

The predetermined amount may be a given amount (for example, 1,000 yen), or may be an amount input and set by the user of the self-terminal on another screen or the like.

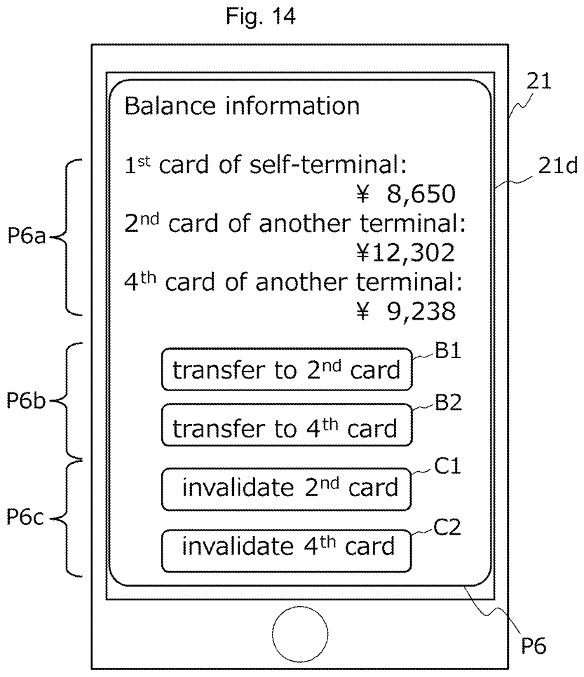

For example, in the fourth state and in the first mobile terminal 21, when an operation for displaying the balance information screen P6 on the first mobile terminal 21 is executed by the user of the first mobile terminal 21, the settlement program installed in the first mobile terminal 21 executes the balance display step. The first mobile terminal 21 accesses the server 30 to acquire the balance information of the second card 12 and the fourth card 14. The balance (8,650 yen) of the first card 11 electrically connected to the self-terminal (the first mobile terminal 21), and the balance (12,302 yen) of the second card 12 and the balance (9,238 yen) of the fourth card 14 which are owned by the user of the first card 11 are displayed on the first display area P6a. A first transfer instruction button B1, a second transfer instruction button B2, a first invalidation instruction button C1, and a second invalidation instruction button C2 are displayed on the second display area P6b (see FIG. 14). The first transfer instruction button B1 is for executing money transfer from the self-terminal (the first mobile terminal 21) to the second card 12. The second transfer instruction button B2 is for executing money transfer from the self-terminal (the first mobile terminal 21) to the fourth card 14. The first invalidation instruction button C1 is for invalidating the second card 12. The second invalidation instruction button C2 is for invalidating the fourth card 14.

When the first transfer instruction button B1 is clicked in a state of FIG. 14, the settlement program installed in the first mobile terminal 21 executes the transfer step, in which a predetermined amount (1,000 yen) is withdrawn from the first card 11 electrically connected to the self-terminal (first mobile terminal 21) and the predetermined amount (1,000 yen) is deposited to the second card 12 corresponding to the first transfer instruction button B1.

That is, the transfer is executed from the electronic money of the first card 11 electrically connected to the first mobile terminal 21, to the electronic money of another IC card (second card 12) corresponding to the user ID: 38 of the first card 11.

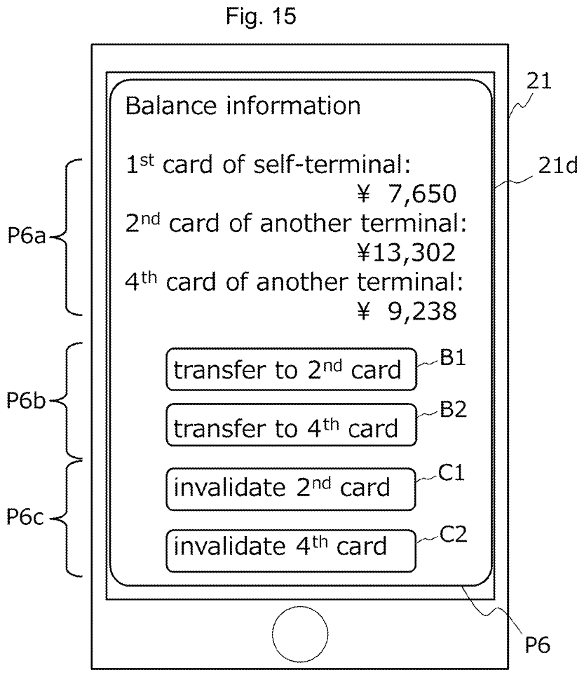

Specifically, on the first card control unit 11b of the first card 11, the deposit/withdrawal information and the balance information regarding the withdrawal (transfer) of the predetermined amount (1,000 yen) are recorded. In addition, the balance information screen P6 (see FIG. 15) which is displayed on the first mobile terminal 21 electrically connected to the first card 11, is updated. Further, the deposit/withdrawal information and the balance information are transmitted to the server 30.

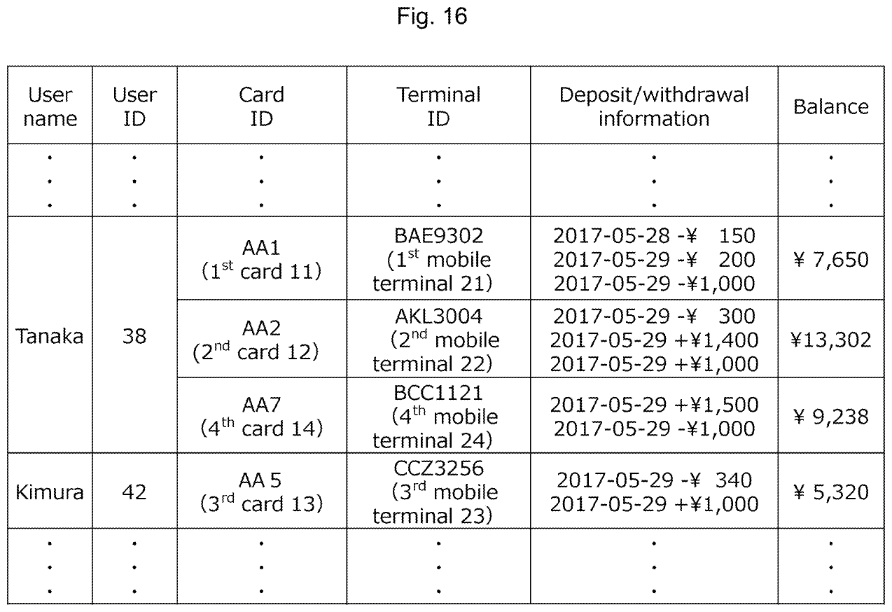

The server 30 updates the database D1, on the basis of the deposit/withdrawal information and the balance information transmitted from the first mobile terminal 21 (see FIG. 16).

In addition, the server 30 transmits the deposit/withdrawal information and the balance information regarding the deposit (transfer) of the predetermined amount (1,000 yen), to the second mobile terminal 22 electrically connected to the second card 12.

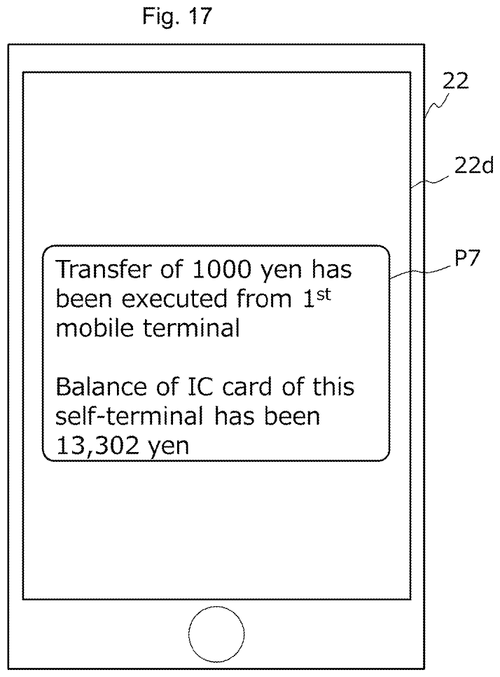

In the second mobile terminal 22, the settlement program executes the transfer step to display the deposit/withdrawal information and the balance information (deposit display screen P7) regarding the deposit (transfer) of the predetermined amount (1,000 yen), received from the server 30 (see FIG. 17).

Thus, on the mobile terminal electrically connected to the IC card, the balance information of another IC card that has a user ID in common with the user of said IC card is allowed to be output.

In addition, the transfer of electronic money between the IC card and said another IC card is allowed to be executed.

In particular, because electronic money is transferred through the mobile terminal electrically connected to the IC card, as long as the mobile terminal on the transmitting side, the mobile terminal on the receiving side, and the server 30 remain in communication with each other, the transfer of electronic money can be executed almost without any time lag.

When the invalidation instruction button is clicked (when a second operation is executed), the settlement program executes the invalidation step in which with respect to another IC card corresponding to the invalidation instruction button, the registration of the combination of the card ID and the terminal ID in the database D1 is deleted, withdrawal of the amount of balance from said another IC card is executed, and deposit of said amount of balance to the IC card electrically connected to the self-terminal is executed.

That is, the activation of said another IC card corresponding to the user ID of the IC card is cancelled (said another IC card is deactivated) to make it impossible for said another IC card to execute any electronic money settlement. Then, the transfer from the electronic money of said another IC card to the IC card electrically connected to the self-terminal is executed.

When the deposit of the amount of balance is executed, the deposit/withdrawal information and the balance information regarding the deposit (transfer) of said amount of balance are recorded on the card control unit of the IC card. In addition, the balance information screen P6 which is displayed on the mobile terminal electrically connected to the IC card is updated. Further, the deposit/withdrawal information, the balance information, and information regarding the invalidation of another IC card (information regarding the instruction of making it impossible for another IC card to execute any electronic money settlement) are transmitted to the server 30.

The server 30 updates the database D1, on the basis of the deposit/withdrawal information, the balance information, and the information regarding the invalidation of another IC card, transmitted from the mobile terminal.

That is, the server 30 deletes the registration of the combination of the card ID of another IC card and the terminal ID in the database D1, and transfers the balance of said another IC card to the balance of the IC card electrically connected to the mobile terminal where the invalidation instruction button has been clicked.

In addition, the server 30 transmits the deposit/withdrawal information and the balance information regarding the withdrawal (transfer) of said amount of balance and the information regarding the invalidation, to another mobile terminal electrically connected to another IC card.

The deposit/withdrawal information and the balance information regarding the withdrawal (transfer) of said amount of balance are recorded on the card control unit of the IC card electrically connected to another mobile terminal.

In addition, in another mobile terminal, the settlement program executes the invalidation step to make it impossible to execute any electronic money deposit/withdrawal (settlement) with the use of the IC card electrically connected to another mobile terminal. Then, the information regarding the invalidation (the invalidation completion screen P8) received from the server 30 is displayed.

The deposit of electronic money to the IC card electrically connected to the mobile terminal where the invalidation instruction button has been clicked may be, however, executed after completing the invalidation in another IC card corresponding to the invalidation instruction button and the processing for the withdrawal of the amount of electronic money balance (after receiving the information regarding the invalidation and the withdrawal processing from the server 30) as a form of the present embodiment.

For example, when the second invalidation instruction button C2 is clicked in a state of FIG. 15, the settlement program installed in the first mobile terminal 21 executes the invalidation step, in which said amount of balance (9,238 yen) is withdrawn from the fourth card 14 corresponding to the second invalidation instruction button C2, said amount of balance (9,238 yen) of the fourth card 14 is deposited to the first card 11 electrically connected to the self-terminal (the first mobile terminal 21), and the fourth card 14 is invalidated.

That is, the transfer is executed from the electronic money of another IC card (the fourth card 14) corresponding to the user ID: 38 of the first card 11 to the electronic money of the first card 11 electrically connected to the first mobile terminal 21.

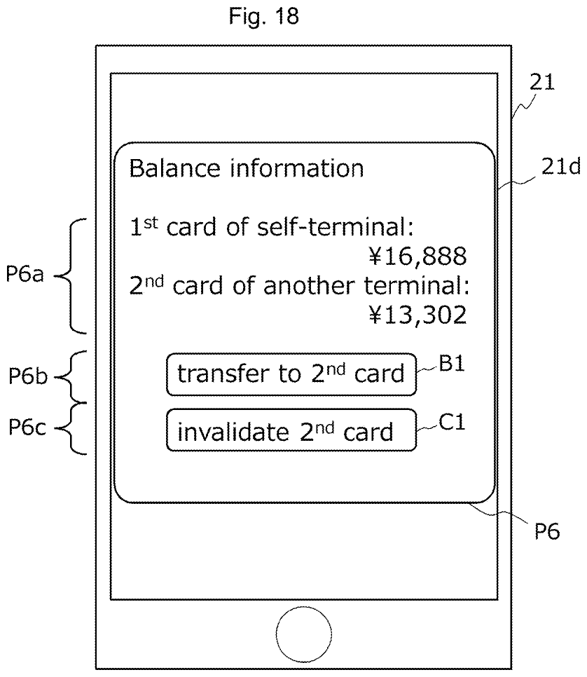

Specifically, on the first card control unit 11b of the first card 11, the deposit/withdrawal information and the balance information regarding the deposit (transfer) of said predetermined amount (9,238 yen) are recorded. In addition, the balance information screen P6 (see FIG. 18) which is displayed on the first mobile terminal 21 electrically connected to the first card 11, is updated. Further, the deposit/withdrawal information, the balance information, and the information regarding the invalidation of the fourth card 14 are transmitted to the server 30.

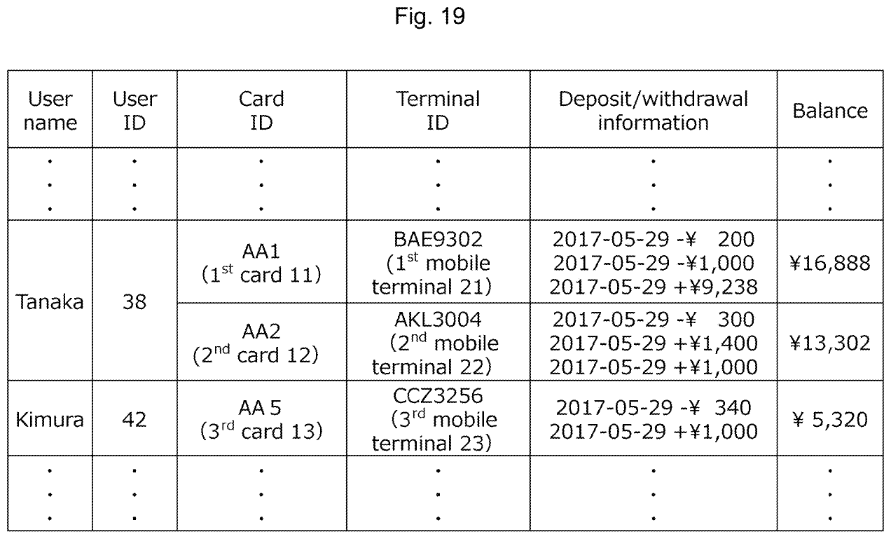

The server 30 updates the database D1, on the basis of the deposit/withdrawal information, the balance information, and the information regarding the invalidation of the fourth card 14, transmitted from the first mobile terminal 21 (see FIG. 19).

That is, the server 30 deletes the registration of the combination of the card ID (AA4) of the fourth card 14 and the terminal ID (BCC1121) of the fourth mobile terminal 24 in the user ID (38) of the database D1.

In addition, the server 30 transmits the deposit/withdrawal information and the balance information regarding the withdrawal (transfer) of said amount of balance (9,238 yen), and the information regarding the invalidation, to the fourth mobile terminal 24 electrically connected to the fourth card 14.

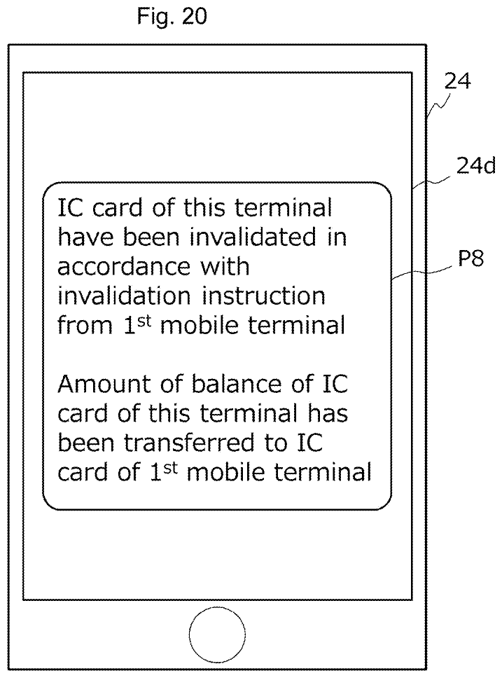

In the fourth mobile terminal 24, the settlement program executes the invalidation step to make it impossible to execute any electronic money deposit/withdrawal with the use of the fourth card 14 electrically connected to the fourth mobile terminal 24. Then, the information regarding the invalidation (invalidation completion screen P8) received from the server 30 is displayed (see FIG. 20).

The deposit of electronic money to the first card 11 may be, however, executed after completing the invalidation in the fourth card 14 corresponding to the second invalidation instruction button C2 and the processing for the withdrawal of the amount of electronic money balance (after receiving the information regarding the invalidation and the withdrawal processing of the fourth card 14 from the server 30) as a form of the present embodiment.

Thus, in such a case where said another IC card has been lost or stolen, the deposit/withdrawal of the electronic money of said another IC card is allowed to be made impossible between the IC card and said another IC card.

It is to be noted that instead of the form in which the invalidation step can be executed in all of the mobile terminals, the invalidation step may be executed (the third display area P6c may be displayed in the balance information screen P6), only with the combination of the mobile terminal and IC card, specified in advance in the database D1 or the like (for example, the combination of the first mobile terminal 21 and the first card 11), as a form of the present embodiment.

In addition, in the invalidation step, as a form of the present embodiment, the deposit/withdrawal of electronic money may be just made impossible between the IC card specified by the invalidation instruction button and the corresponding mobile terminal, without executing any transfer of the amount of balance.

The several embodiments of the present invention have been described, but these embodiments have been presented as examples, and are not intended to limit the scope of the invention. These embodiments can be put into practice in other various forms, and various omissions, substitutions, and changes can be made to the embodiments without departing from the spirit of the invention. These embodiments and modifications thereof are included in the scope and sprit of the invention, as well as in what is claimed in the claims and equivalents thereto.

### REFERENCE SIGNS LIST

1 settlement system
11 to 14 first card to fourth card
11a to 13a first antenna unit to third antenna unit
11b to 13b first card control unit to third card control unit
21 to 25 first mobile terminal to fifth mobile terminal
21a to 23a first communication unit to third communication unit
21b to 23b first recording unit to third recording unit
21c to 23c first control unit to third control unit
21d to 23d first display to third display
21e to 23e first connection unit to third connection unit
30 server
31 server communication unit
33 server recording unit
35 server control unit
51, 52 first reader/writer, second reader/writer
70 predetermined terminal
B1, B2 first transfer instruction button, second transfer instruction button
C1, C2 first invalidation instruction button, second invalidation instruction button
D1 database
P1 available display screen
P2 confirmation display screen
P3 rejection display screen
P4 self-terminal information screen
P5 other-terminal information screen
P6 balance information screen
P6a to P6c first display area to third display area
P7 deposit display screen
P8 invalidation completion screen
T1, T2 first time, second time

1. A non-transitory computer readable medium storing a settlement program causing a computer to execute the settlement program, wherein:
the medium is installed in a mobile terminal that removably holds and electrically connects an IC card comprising an antenna and a card controller that performs electronic money settlement,
the mobile terminal is capable of communicating with a server via a network,
the settlement is executed at least in a case where the antenna is located in a communication region of a reader/writer, and
the settlement program executes:
a reading step of reading information from the IC card; and
a first determination processing step of determining whether to make the IC card in a state of which the mobile terminal holds and electrically connects be in a state where the settlement is enabled, based on information obtained in the reading step and information from the server.

2. The non-transitory computer readable medium according to claim 1,
wherein for each user, a database that indicates a relation among a user ID of the user of the IC card, a card ID of the IC card, and a terminal ID of the mobile terminal, is the information from the server, and
in a case where a combination of the card ID of the IC card and the terminal ID of the mobile terminal, and a combination of the card ID of another IC card other than the IC card and the terminal ID of another mobile terminal other than the mobile terminal are set in the database to correspond to the user ID, the settlement program executes a balance display step to make the mobile terminal to display balance information on the electronic money in the IC card and balance information on the electronic money in said another IC card.

3. The non-transitory computer readable medium according to claim 2,
wherein in the balance display step, in a case where a first operation on the mobile terminal is executed, at least a part of the balance of the electronic money in the IC card is added to the balance of the electronic money in said another IC card, and to make the mobile terminal to display the balance of the electronic money in the IC card after the subtraction and the balance of the electronic money in said another IC card after the addition is executed.

4. The non-transitory computer readable medium according to claim 2,
wherein in the balance display step, in a case where a second operation on the mobile terminal is executed, to make the server to transmit information regarding an instruction of making it impossible for said another IC card to execute the settlement is executed.

5. The non-transitory computer readable medium according to claim 1,
wherein in the first determination processing step, if it was not determined to make the settlement enabled state, the settlement program executes a second determination processing step of determining whether to make the IC card electrically connected to the mobile terminal be in the state where the settlement is enable, based on input of information via the mobile terminal.

6. The non-transitory computer readable medium according to claim 5,
wherein in a case where at least one of the user ID and a string corresponding to the user ID is input as the information input via the mobile terminal, it is determined to make the settlement enabled state in the second determination processing step.

7. The non-transitory computer readable medium according to claim 1,
wherein a card ID of the IC card and a user ID of a user of the IC card are the information read from the IC card,
for each user, a database that indicates a relation among the user ID, the card ID, and a terminal ID of the mobile terminal is the information from the server, and
in a case where a combination of, the card ID and the user ID contained in the information read from the IC card, and the terminal ID of the mobile terminal that has read the card ID and the user ID, is contained in the database, it is determined to make the settlement enabled state in the first determination processing step.

8. A method for electronic money settlement in a mobile terminal that removably holds and electrically connects an IC card comprising an antenna and a card controller that performs the electronic money settlement,
the settlement is executed at least in a case where the antenna is located in a communication region of a reader/writer, and
the settlement method executes:
a reading step of reading information from the IC card; and
a first determination processing step of determining whether to make the IC card in a state of which the mobile terminal holds and electrically connects be in a state where the settlement is enabled, based on information obtained in the reading step and information from a server that communicates via a network.

9. The settlement method according to claim 8,
wherein for each user, a database that indicates a relation among a user ID of the user of the IC card, a card ID of the IC card, and a terminal ID of the mobile terminal is the information from the server, and
in a case where a combination of the card ID of the IC card and the terminal ID of the mobile terminal, and a combination of the card ID of another IC card other than the IC card, and the terminal ID of another mobile terminal other than the mobile terminal are set in the database to correspond to the user ID, the settlement method executes a balance display step to make the mobile terminal to display balance information on the electronic money in the IC card and balance information on the electronic money in said another IC card.

10. An IC card comprising an antenna and a card controller that performs electronic money settlement,
wherein the IC card is removably held by and electrically connected to a mobile terminal,
the settlement is executed at least in a case where the antenna is located in a communication region of a reader/writer, and
a first determination processing step is executed to determine whether to make the IC card in a state of which the mobile terminal holds and electrically connects be in a state where the settlement is enabled, based on information read from the IC card by the mobile terminal and information from a server that communicates with the mobile terminal via a network, and after the first determination processing step, the settlement enabled state is made.

11. The IC card according to claim 10,
wherein for each user, a database that indicates a relation among a user ID of the user of the IC card, a card ID of the IC card, and a terminal ID of the mobile terminal is the information from the server, and
in a case where a combination of the card ID of the IC card and the terminal ID of the mobile terminal, and a combination of the card ID of another IC card other than the IC card and the terminal ID of another mobile terminal other than the mobile terminal are set in the database to correspond to the user ID, a balance display step is executed to make the mobile terminal to display balance information on the electronic money in the IC card and balance information on the electronic money in said another IC card.

12. A settlement system comprising:
a first IC card for use in electronic money settlement;
a first mobile terminal in which the first IC card is removably held by and electrically connected to;
a second mobile terminal that is another mobile terminal other than the first mobile terminal, the first IC card being electrically connected in a removable manner to the second mobile terminal; and
a server that communicates with the first mobile terminal and the second mobile terminal via a network,
wherein the settlement is executed at least in a case where the antenna is located in a communication region of a reader/writer,
when the first IC card is held by and electrically connected to the first mobile terminal, it is determined whether to make the first IC card electrically connected to the first mobile terminal be in a state where the settlement is enabled, based on information read from the first IC card and information from the server, and
when the first IC card is removed from the first mobile terminal, and held by and electrically connected to the second mobile terminal, it is determined whether to make the first IC card electrically connected to the second mobile terminal be in a state where the settlement is enabled, based on information read from the first IC card and information from the server.

13. The settlement system according to claim 12, further comprising a second IC card for use in the electronic money settlement, the second IC card being another IC card other than the first IC card,
wherein for each user, a database that indicates a relation among a user ID of the user of the IC card, a card ID of the IC card, and a terminal ID of the mobile terminal is contained in the information from the server, and
in a case where a combination of the card ID of the first IC card and the terminal ID of the first mobile terminal, and a combination of the card ID of the second IC card and the terminal ID of the second mobile terminal are set in the database to correspond to the user ID, balance information on the electronic money in the first IC card and balance information on the electronic money in the second IC card are displayed on the first mobile terminal.
